(19) United States
(12) Patent Application Publication
(10) Pub. No.: US 2025/0363312 A1
(43) Pub. Date: Nov. 27, 2025

(54) INFORMATION PROCESSING APPARATUS, CONTROL METHOD OF INFORMATION PROCESSING APPARATUS, AND NON-TRANSITORY COMPUTER-READABLE STORAGE MEDIUM

(71) Applicant: NEC Corporation, Tokyo (JP)

(72) Inventors: Masaki INOKUCHI, Tokyo (JP); Takayuki Kuroda, Tokyo (JP); Masaharu Morimoto, Tokyo (JP)

(73) Assignee: NEC Corporation, Tokyo (JP)

(21) Appl. No.: 19/203,504

(22) Filed: May 9, 2025

(30) Foreign Application Priority Data
May 27, 2024 (JP) 2024-085396

(51) Int. Cl. G06F 40/40; G06F 8/20

(52) U.S. Cl. CPC G06F 40/40; G06F 8/20

(57) ABSTRACT

An information processing apparatus includes a storage means, a generation means, and a presentation means. The storage means stores explanatory information for each element that can be included in structured design information. The generation means generates a prompt to be input into a language model, the prompt instructing the language model to generate an explanatory text for the structured design information using the stored explanatory information. The presentation means presents the acquired explanatory text of the structured design information by inputting the generated prompt into the language model to a user.

### INCORPORATION BY REFERENCE

This application is based upon and claims the benefit of priority from Japanese Patent Application No. 2024-085396, filed on May 27, 2024, the disclosure of which is incorporated herein in its entirety by reference.

### TECHNICAL FIELD

The present invention is related to an information processing apparatus, a control method of an information processing apparatus and a non-transitory computer-readable storage medium.

### BACKGROUND ART

There exists a technology that supports the design of systems and software.

For example, Patent Literature 1 (JP2022-114927A) describes displaying a graph structure in a process of automated design without causing a decrease in processing speed or an increase in processing time.

A display apparatus of Patent Literature 1 includes an input unit, a modification application unit, and a display unit. The input unit inputs an initial graph structure and a conversion content.

The modification application unit refines the initial graph structure by continuously applying the conversion content, and generates an aggregated graph structure by continuously applying the conversion content to the initial graph structure while retaining a component deleted in the refinement process. The display unit displays one of a plurality of graph structures at the same position on a screen. The modification application unit determines the position of the components on the screen in such a way that the components that exist in the aggregate graph structure do not overlap with each other. The display unit, in displaying a single graph structure, displays the components that exist in a single graph structure at the same position on the screen as the position determined by the aggregate graph structure.

It is possible to acquire concrete design information from a system requirement by using automated design technology. Here, the automated design technology often outputs design information that is structured in a predetermined format. Structured design information has the advantage of being easy to handle by computers and so on, but it can be difficult for humans to understand.

### SUMMARY

It is a main object of the present invention to provide an information processing apparatus, a control method of an information processing apparatus and a non-transitory computer-readable storage medium storing that contribute to enabling a user to easily understand structured design information.

According to a first aspect of the present invention, there is provided an information processing apparatus, including: a storage means that stores explanatory information for each element that can be included in structured design information; a generation means that generates a prompt to be input into a language model, the prompt instructing the language model to generate an explanatory text for the structured design information using the stored explanatory information; and a presentation means that presents the acquired explanatory text of the structured design information by inputting the generated prompt into the language model to a user.

According to a second aspect of the present invention, there is provided a control method of an information processing apparatus, the control method including: a storage step that stores explanatory information for each element that can be included in structured design information; a generation step that generates a prompt to be input into a language model, the prompt instructing the language model to generate an explanatory text for the structured design information using the stored explanatory information; and a presentation step that presents the acquired explanatory text of the structured design information by inputting the generated prompt into the language model to a user.

According to a third aspect of the present invention, there is provided a non-transitory computer-readable storage medium storing a program causing a computer mounted on an information processing apparatus to perform processing for: a storage processing that stores explanatory information for each element that can be included in structured design information; a generation processing that generates a prompt to be input into a language model, the prompt instructing the language model to generate an explanatory text for the structured design information using the stored explanatory information; and a presentation processing that presents the acquired explanatory text of the structured design information by inputting the generated prompt into the language model to a user.

### BRIEF DESCRIPTION OF THE DRAWINGS

Exemplary features and advantages of the present invention will become apparent from the following detailed description when taken with the accompanying drawings in which:

FIG. 1 is a diagram illustrating an outline of an example embodiment;

FIG. 2 is a flowchart illustrating an operation of an example embodiment;

FIG. 3 is a diagram illustrating an example of a schematic configuration of an information processing system according to an example embodiment of the present disclosure;

FIG. 4 is a diagram illustrating an example of a processing configuration of an assistance apparatus according to the example embodiment of the present disclosure;

FIG. 5 is a diagram illustrating an example of explanatory information according to the example embodiment of the present disclosure;

FIG. 6 is a diagram illustrating an example of a prompt according to the example embodiment of the present disclosure;

FIG. 7 is a diagram illustrating an example of a display of a terminal according to the example embodiment of the present disclosure;

FIG. 8 is a diagram illustrating an example of the display of the terminal according to the example embodiment of the present disclosure;

FIG. 9 is a diagram illustrating an example of the display of the terminal according to the example embodiment of the present disclosure;

FIG. 10 is a flowchart illustrating an example of an operation of the assistance apparatus according to the example embodiment of the present disclosure;

FIG. 11 is a diagram illustrating an example of the display of the terminal according to the example embodiment of the present disclosure;

FIG. 12 is a diagram illustrating concretization information according to the example embodiment of the present disclosure;

FIG. 13 is a diagram illustrating an example of the prompt according to the example embodiment of the present disclosure;

FIG. 14 is a diagram illustrating an example of the display of the terminal according to the example embodiment of the present disclosure;

FIG. 15 is a diagram illustrating an example of the display of the terminal according to the example embodiment of the present disclosure;

FIG. 16 is a diagram illustrating an example of the display of the terminal according to the example embodiment of the present disclosure;

FIG. 17 is a diagram illustrating an example of the display of the terminal according to the example embodiment of the present disclosure;

FIG. 18 is a diagram illustrating an example of the display of the terminal according to the example embodiment of the present disclosure;

FIG. 19 is a diagram illustrating an example of a processing configuration of the assistance apparatus according to the example embodiment of the present disclosure;

FIG. 20 is a diagram illustrating an example of the display of the terminal according to the example embodiment of the present disclosure;

FIG. 21 is a diagram illustrating an example of the display of the terminal according to the example embodiment of the present disclosure; and

FIG. 22 is a diagram illustrating an example of a configuration of a hardware of the assistance apparatus of the present disclosure.

### EXAMPLE EMBODIMENT

First, an outline of an example embodiment will be described. In the following outline, various components are denoted by reference characters for the sake of convenience. That is, the following reference characters are used as examples to facilitate the understanding of the present invention. Thus, the description of the outline is not intended to impose any limitations. In addition, unless otherwise specified, an individual block illustrated in the drawings represents a configuration of a functional unit, not a hardware unit. An individual connection line between blocks in the drawings signifies both one-way and two-way directions. An arrow schematically illustrates a principal signal (data) flow and does not exclude bidirectionality. In the present description and drawings, elements that can be described in a like way will be denoted by a like reference character, and redundant description thereof will be omitted as needed.

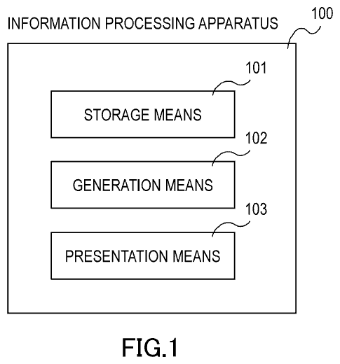

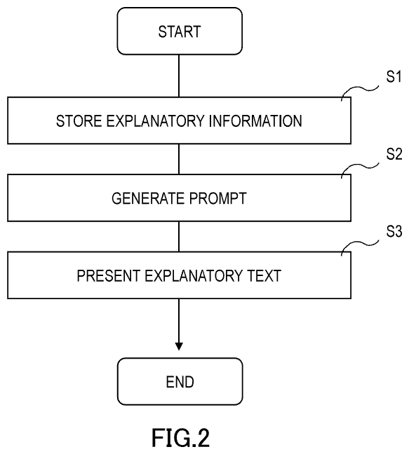

An information processing apparatus 100 according to an example embodiment includes a storage means 101, a generation means 102, and a presentation means 103 (see FIG. 1). The storage means 101 stores explanatory information for each element that can be included in structured design information (step S1 in FIG. 2). The generation means 102 generates a prompt to be input into a language model, the prompt instructing the language model to generate an explanatory text for the structured design information using the stored explanatory information (step S2). The presentation means 103 presents the acquired explanatory text of the structured design information by inputting the generated prompt into the language model to a user (step S3).

The information processing apparatus 100 generates the explanatory text of the structured design information using the predetermined explanatory information. More specifically, the information processing apparatus 100 uses the prompt to be input to the language model to instruct the language model to generate the explanatory text for the structured design information using the stored explanatory information. The language model generates the explanatory text for the design information that is easier for humans to understand, while referring to (taking into account) the design information. The information processing apparatus 100 presents the generated explanatory text to the user. As a result, the user can easily understand the structured design information.

Hereinafter, specific example embodiments will be described in more detail with reference to drawings.

### First Example Embodiment

A first example embodiment will be described in more detail with reference to drawings.

### [System Configuration and Schematic Operation of System]

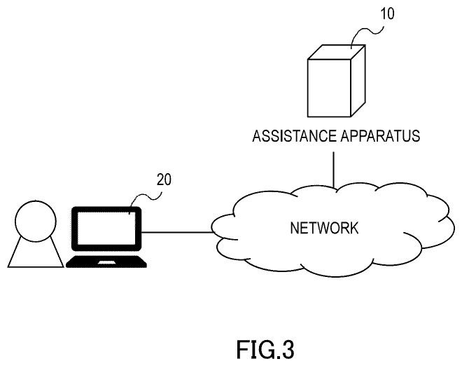

As shown in FIG. 3, the information processing system according to the first example embodiment includes an assistance apparatus 10 and a terminal 20.

The assistance apparatus 10 is the information processing apparatus that assists system design by a user. For example, the assistance apparatus 10 is a server installed on a network (on a cloud).

The user accesses the assistance apparatus 10 by operating the terminal 20. The user inputs various information into the assistance apparatus 10 and acquires various information from the assistance apparatus 10.

The assistance apparatus 10 acquires a system requirement (information that organizes functions and performance required for the system; also referred to as a requirement definition). For example, the assistance apparatus 10 acquires the system requirement (requirement definition, requirement information) described in a natural language from the user.

For example, the assistance apparatus 10 acquires the system requirement from a person in charge of a vendor company that is responsible for system development. The person in charge of the vendor company creates a system requirement in response to a request for the system from a client company. The person in charge operates the terminal 20 and inputs the system requirement, and so on, into the assistance apparatus 10.

The assistance apparatus 10 generates design information that concretizes an element of the acquired system requirement (for example, a component, a performance indicator). The assistance apparatus 10 automatically generates the design information (draft system configuration) that achieves the system requirement.

At that time, the assistance apparatus 10 generates structured design information. For example, the assistance apparatus 10 generates design information in a predetermined format such as JSON (JavaScript Object Notation) format.

For example, in the JOSN format, it is specified which key should be used to represent a concept, and in the case where structuring is performed, an appropriate key is selected to represent the concept. For example, in the case where “Memory” is defined as the key for representing computer memory, expressions such as “main storage apparatus” and “RAM” are not used, and the key (vocabulary) is standardized as “Memory”.

The assistance apparatus 10 presents the generated design information (structured design information) to the user.

Here, the structured design information is convenient for a computer or program to handle, but it may be difficult for a person to understand the structured design information. Therefore, the assistance apparatus 10 generates an explanatory text of the structured design information (information related to explanation of the design information) instead of or in addition to the structured design information, and presents the explanatory text generated by the assistance apparatus 10 to the user.

At that time, the assistance apparatus 10 generates the explanatory text of the structured design information using information related to an explanation of each element that can be included in the structured design information (hereinafter referred to as “explanatory information”). More specifically, the assistance apparatus 10 generates a prompt that instructs a language model to generate an explanatory text of the structured design information using an explanatory information prepared in advance. The assistance apparatus 10 generates the above explanatory text by inputting the generated prompt to the language model.

The assistance apparatus 10 generates the explanatory text related to the structured design information from the perspective of the function and/or performance of each element that can be included in the design information.

Next, a detailed description of the assistance apparatus 10 according to the first example embodiment will be provided.

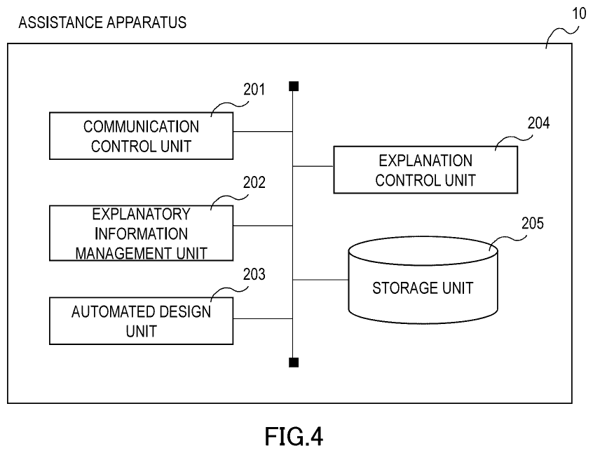

FIG. 4 is a diagram illustrating an example of a processing configuration (processing module) of the assistance apparatus 10 according to an example embodiment of the present application disclosed. Referring to FIG. 4, the assistance apparatus 10 includes a communication control unit 201, an explanatory information management unit 202, an automated design unit 203, an explanation control unit 204, and a storage unit 205.

The communication control unit 201 is means for controlling communication with other apparatuses. For example, the communication control unit 201 receives data (packets) from the terminal 20. In addition, the communication control unit 201 transmits data to the terminal 20. The communication control unit 201 gives data received from other apparatuses to other processing modules. The communication control unit 201 transmits data acquired from other processing modules to other apparatuses. In this way, other processing modules transmit and receive data to and from other apparatuses via the communication control unit 201. The communication control unit 201 includes a function as a receiving unit that receives data from other apparatuses and a function as a transmitting unit that transmits data to other apparatuses.

The explanatory information management unit 202 is means for performing control and management related to explanatory information required for generating an explanatory text for structured design information.

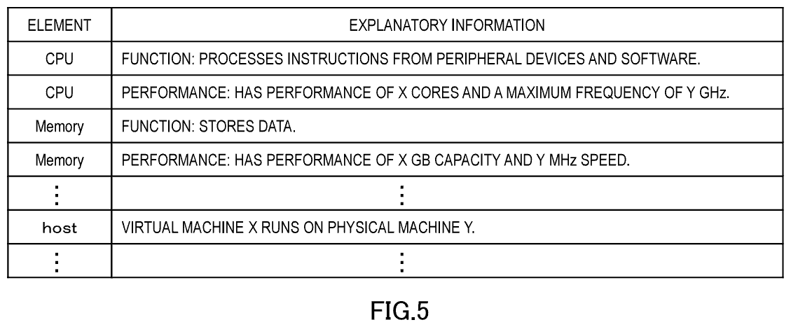

The explanatory information management unit 202 acquires explanatory information from a system administrator, or the like. For example, the explanatory information management unit 202 acquires the explanatory information using a GUI (Graphical User Interface) or USB (Universal Serial Bus) memory, and so on. The explanatory information management unit 202 stores the acquired explanatory information in the storage unit 205. For example, the explanatory information management unit 202 stores the explanatory information such as that described in FIG. 5 in the storage unit 205.

The explanatory information includes an explanation of each component included in the structured design information.

More specifically, the design information includes an explanation of the “function” of each component included in the structured design information. For example, the explanatory information includes explanations such as “CPU: Processes instructions received from peripheral devices and software” and “Memory: Stores data”.

Alternatively, the design information includes an explanation of “performance” for each component included in the structured design information. For example, the explanatory information includes explanations such as “CPU: Having performance of X cores and Y GHz maximum frequency” and “Memory: Having X GB capacity and Y MHz speed”.

It should be noted that, as shown in FIG. 5, it is also possible to clearly indicate whether the explanatory information for the same component is an explanation related to “function” or an explanation related to “performance”.

Alternatively, the design information includes an explanation related to the relationships between the components that may be included in the structured design information.

For example, structured design information indicating that virtual machine A operates on physical machine B is described as follows:

```
“relation”: {
    “src”: “B”,
  “dst”: “A”,
  “relation_type”: “host”
}
```

In this case, explanatory information such as “Virtual machine X runs on physical machine Y.” is registered in the assistance apparatus 10 as explanatory information for “host”, which indicates the relationship type (relation_type).

It should be noted that, as shown in the above example, the explanatory information may be indicated by a label with a specific numerical value or configuration. For example, in the above “CPU: Having performance of X cores and Y GHz maximum frequency”, X and Y are labels. Also, in the explanatory information related to the relationship type “host”, “Virtual machine X runs on physical machine Y.”, X and Y are labels.

The label described in such explanatory information is utilized as an identifier to insert concrete information in generating the explanatory text of the structured design information. In other words, the explanatory information containing the label is utilized as a template in generating the explanatory text of the structured design information.

A specific utilization of the explanatory information containing the label will be described below.

The automated design unit 203 is means for performing automated design related to a system requirement (requirement definition, requirement information) acquired from a user. More specifically, the automated design unit 203 acquires the system requirement from the user and also generates structured design information from the acquired system requirement.

The automated design unit 203 acquires the system requirement, which is the target for generating the design information, from the user using a GUI or the like.

In case where the acquired system requirement is not structured, the automated design unit 203 structures the acquired system requirement. The automated design unit 203 converts the system requirement into a system requirement having a predetermined structure (structured requirement definition).

For example, the automated design unit 203 acquires corresponding structured system requirement by inputting the system requirement into a language model. For example, the automated design unit 203 generates a prompt that includes an instruction such as “Please convert the system requirement described in the input area into JSON format.” A copy of the system requirement acquired from the user is described in the input area of the prompt.

The automated design unit 203 structures the system requirement acquired from the user by inputting the generated prompt into the language model.

Furthermore, the automated design unit 203 generates concrete design information from the structured system requirement using any means. The automated design unit 203 narrows down the optimal system configuration from among a plurality of system configurations acquired by concretizing a component and performance indicator included in the system requirement, and generates the narrowed-down system configuration as design information (structured design information).

For example, the automated design unit 203 generates concrete design information using various algorithms related to a multi-objective optimization problem. The system requirement handled by the automated design unit 203 is structured in a manner that allows mechanical processing. Therefore, the automated design unit 203 can generate concrete design information by applying an algorithm that solves the multi-objective optimization problem to the structured system requirement.

At that time, the automated design unit 203 may generate the concrete design information for the structured system requirement using technical information prepared in advance.

The technical information includes a list of parts that can be adopted in the system (a list that includes a performance indicator and price of available parts, and so on), and general technical common knowledge (general constraint; for example, maximum length of a LAN (Local Area Network) cable, and so on).

The automated design unit 203 uses the technical information, and so on, to generate the concrete design information for the system requirement from the perspectives of system reliability, system consistency, and appropriateness of cost required for system construction, and so on.

For example, with respect to the system consistency, the automated design unit 203 selects a part that satisfy the structured system requirement from the list of available parts, and determines that the structured system requirement is feasible if there is a combination of parts that satisfy all the requirements (objectives). The automated design unit 203 adopts the combination of parts that is determined to be feasible as the concrete design information of the system requirement.

On the other hand, if there is no combination of parts that satisfies all the requirements, the automated design unit 203 determines that the structured system requirement is not feasible.

Alternatively, the automated design unit 203 generates the concrete design information corresponding to the system requirement by using the technical information and the performance indicator described in the structured system requirement. The automated design unit 203 refers to cost and performance of the part described in the technical information, or to technical common knowledge, and determines that the design information cannot be generated with respect to the system requirement that requires extremely low cost, extremely high performance, or is physically not feasible to achieve.

It should be noted that the algorithm for solving the multi-objective optimization problem is different from the purpose of the present application disclosed, so a detailed description will be omitted.

Alternatively, the automated design unit 203 may utilize the automated design technology disclosed in Reference Document 1 below, which is specialized for system development, to determine whether the system requirement is feasible and to generate concrete design information.

Reference Document 1: Japanese Unexamined Patent Application Publication No. JP2021-135625

Reference Document 1 discloses a technique for generating concretized design information by repeating an operation that progressively concretizes an abstract system configuration included in a given system requirement.

Automated design algorithm disclosed in Reference Document 1 targets configuration information, such as requirement described in a predetermined format, for concretization The configuration information is described by a plurality of components and relationships among the components. For example, in the configuration information, the configuration element is expressed as a node in a graph, and a relationship among configuration elements is expressed as an edge in a graph. Each configuration element and relationship includes a unique ID, a type that represents its type, an attribute value, and so on.

In the case where the element (the component and the relationship among the components) is abstract, the automated design algorithm uses a concretization rule that defines an option for a method of realization that achieves the abstract element (concretization method). Furthermore, the automatic design algorithm derives a design draft by taking the configuration information (requirements to be concretized) as an input and concretizing the input in a stepwise and searching manner. A search tree with a tree structure is formed by recording the path of the search. A node of the search tree (node) corresponds to either a requirement, a draft configuration, or a design result, and a branch (edge) corresponds to a one-step concretization operation that generates the draft configuration from the requirement or generates other draft configuration or design result from the draft configuration.

The automated design algorithm performs a search processing that takes an input requirement (requirement information) as an initial state and a concrete design result as a target state. The automated design algorithm selects a state corresponding to a promising draft configuration and repeats the processing of generating a plurality of next states by concretizing the draft configuration, until a concrete configuration is acquired. Once the automated design algorithm first acquires the concrete draft configuration, the automated design algorithm outputs the concrete draft configuration as the design result (design information).

It should be noted that the automated design algorithm (automated design technology) is different from the purpose of the present application disclosed, so a more detailed description will be omitted.

The automated design unit 203 uses the technology disclosed in Reference Document 1 to determine that the system requirement is feasible if the design information (draft system configuration) corresponding to the system requirement is acquired. On the other hand, the automated design unit 203 determines that the system requirement is not feasible if the design information corresponding to the system requirement is not acquired.

If the system requirement is determined to be feasible, the automated design unit 203 handles the design information (draft system configuration) corresponding to the system requirement as design information to be presented to the user. The automated design unit 203 passes the generated design information (structured design information) to the explanation control unit 204.

The explanation control unit 204 is means for performing control related to the explanation (explanatory text) of the design information (structured design information) generated by the automated design unit 203.

The explanation control unit 204 includes a function as a generation means and a function as a presentation means. The explanation control unit 204, which is the generation means, generates a prompt to be input to a language model, and generates the prompt that instructs the language model to generate an explanatory text of the structured design information using explanatory information stored in the storage unit 205. The explanation control unit 204, which is the presentation means, presents the user with an explanatory text for the structured design information acquired by inputting the generated prompt into the language model.

More specifically, the explanation control unit 204 generates a prompt that instructs the language model to generate an explanatory text of the structured design information based on the explanatory information (component-by-component explanatory information) stored in the storage unit 205.

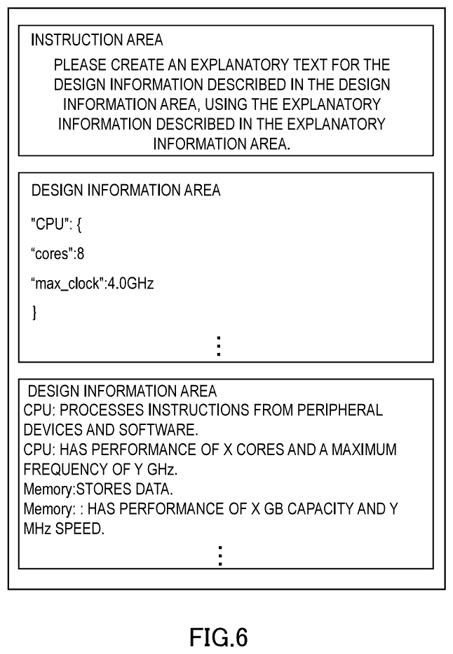

For example, the explanation control unit 204 generates a prompt as shown in FIG. 6. As shown in FIG. 6, the explanation control unit 204 generates a prompt that includes an instruction area, a design information area, and an explanatory information area.

In the instruction area, an instruction related to generating the structured design information is described. For example, in the instruction area, an instruction such as “Please create an explanatory text for the design information described in the design information area using the explanatory information described in the explanatory information area.” is described.

In the design information area, the design information (structured design information) generated by the automated design unit 203 is described.

In the explanatory information area, the explanatory information stored in the storage unit 205 is described (transcribed).

The explanation control unit 204 acquires an explanatory text of the structured design information by inputting the generated prompt into the language model.

As an example, the language model may be referred to as a large-scale language model, but it is not limited thereto.

The language model is a machine learning model (also called a generative model) that inputs language and outputs language. The language model learns the relationships between words in a sentence, and is the model that generates a related character string from a target character string that is related to the target character string. By using the language model that has learned sentences and phrases in various contexts, it is possible to generate the related character string with appropriate content that is related to the target character string.

Once a prompt generated based on an input system request, and so on, is input, the language model outputs an answer corresponding to the prompt.

The learning method of the language model is not particularly limited, but as an example, the language model may be learned to output at least one sentence that includes the input character string. As a specific example, the language model is a GPT (Generative Pre-trained Transformer) that outputs a sentence including the input character string by predicting a character string that has a high probability of following the input character string.

Other examples of language models include, for example, T5 (Text-to-Text Transfer Transformer), BERT (Bidirectional Encoder Representations from Transformers), RoBERTa (Robustly optimized BERT approach), ELECTRA (Efficiently Learning an Encoder that Classifies Token Replacements Accurately), and so on.

The system administrator, or the like, inputs (implements) into the assistance apparatus 10 a language model generated using a large amount of design materials, specifications, and so on related to system design.

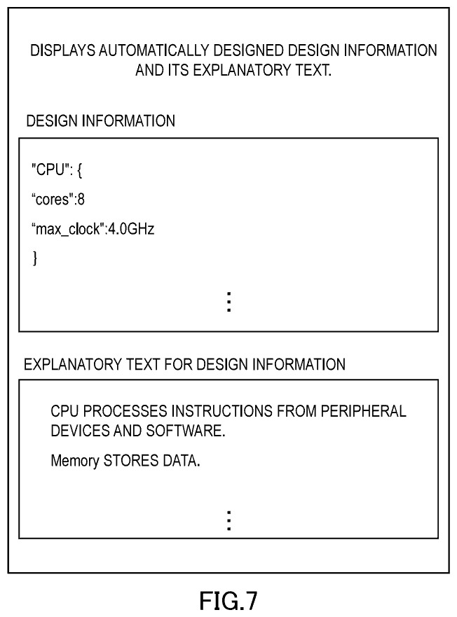

The explanation control unit 204 generates an explanation text, for example, such as the one shown in FIG. 7, and displays the explanation text on the terminal 20. At that time, as shown in FIG. 7, the explanation control unit 204 may display the design information (structured design information) generated by the automated design unit 203 together with the explanation text.

It should be noted that the prompt shown in FIG. 6 is merely an example. For example, the explanation control unit 204 may generate a prompt that instructs to generate an explanatory text in which specific information (a numerical value) is set to the label described in the explanatory information.

For example, the explanation control unit 204 may generate a prompt such as “In case where labels X and Y are described in the explanatory text of the explanatory information area, please create an explanatory text of the design information by inserting the numerical value of the design information described in the design information area into the label.”

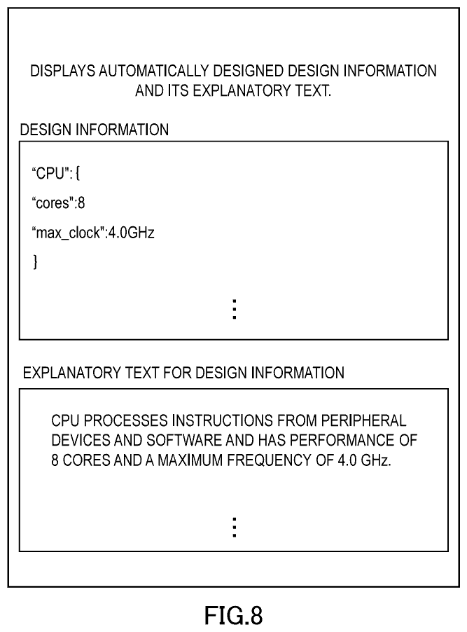

In this way, the explanation control unit 204 may acquire information corresponding to explanatory information labels X, Y, and so on from the structured design information, supplement the explanatory information, and generate a prompt that generates an explanatory text. The explanation control unit 204 may generate the explanatory text by inputting the generated prompt into the language model. That is, the explanatory text described in the explanatory information area may be used as a template to generate the explanatory text. In this case, the explanation control unit 204 generates the explanatory text as shown in FIG. 8 and displays the explanatory text on the terminal 20.

Additionally, as described above, the explanatory information may include an explanation related to the relationship between the components included in the structured design information. In this case as well, the specific configuration and numerical value described in the design information are inserted into the label described in the explanatory information, and an explanatory text is generated. For example, in the case where the above-mentioned virtual machine A runs on the physical machine B, the specific machine names described in the design information are inserted into the labels X and Y described in the explanatory text to generate an explanatory text such as “Virtual machine A runs on physical machine B”.

Alternatively, the explanation control unit 204 may generate a prompt that instructs the language model to generate an explanatory text that explains the structured design information from a function perspective or a performance perspective.

For example, the explanation control unit 204 generates a prompt in which the instruction area is described as “Please explain the components of the design information described in the design information area from the perspective of function, using the explanatory information described in the explanatory information area. In this case, the explanation control unit 204 generates an explanation text that describes each component from the function perspective, as shown in FIG. 7, and presents the explanation text to the user.

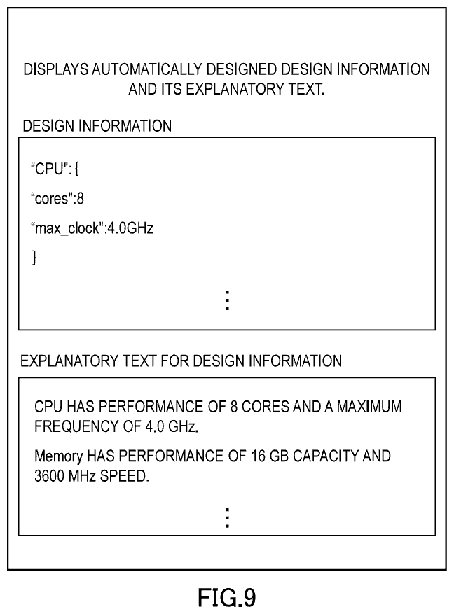

Alternatively, the explanation control unit 204 generates a prompt in which the instruction area is described as “Please explain the component of the design information described in the design information area from the performance perspective using the explanatory information described in the explanatory information area.” In this case, the explanation control unit 204 generates an explanatory text that explains the component of the design information from the performance perspective, as shown in FIG. 9, and presents the explanatory text to the user.

The storage unit 205 is means for storing information necessary for an operation of the assistance apparatus 10. The storage unit 205 stores explanatory information for each element that can be included in the structured design information.

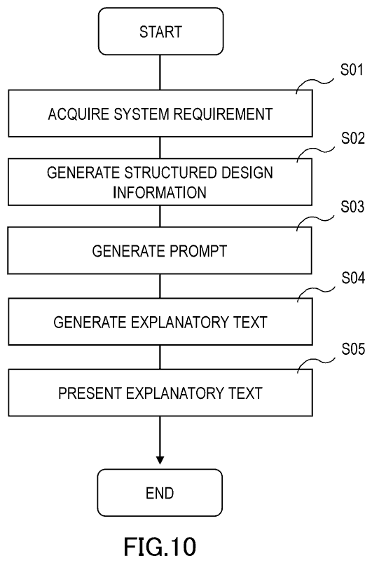

The operation of the assistance apparatus 10 is summarized in the flowchart shown on FIG. 10.

The assistance apparatus 10 acquires a system requirement from a user (step S01).

The assistance apparatus 10 generates structured design information from the acquired system requirement (step S02).

The assistance apparatus 10 generates a prompt for a language model to generate an explanatory text of the structured design information, based on the explanatory information registered in advance (by referring to the explanatory information or considering the explanatory information) (step S03).

The assistance apparatus 10 generates the explanatory text by inputting the generated prompt into the language model (step S04).

The assistance apparatus 10 presents the generated explanatory text to the user (step S05).

### [Terminal]

A detailed description of the terminal 20 will be omitted. Examples of the terminal 20 include a portable terminal device such as a smartphone, a portable phone, a game console, or a tablet and a computer (a personal computer or a laptop computer). The terminal 20 can be any equipment or device as long as the terminal 20 can accept an operation by a user and can communicate with the assistance apparatus 10.

Next, variations according to the first example embodiment will be described.

### <Variation 1>

In the above example embodiment, the case where the assistance apparatus 10 includes the automated design unit 203 is described. However, the assistance apparatus 10 does not necessarily have to include the automated design unit 203. In this case, the explanation control unit 204 may acquire the structured design information (draft system configuration) using a GUI, and so on.

As described above, the assistance apparatus 10 according to the first example embodiment generates an explanatory text for the structured design information based on design information (plain and concise information described in natural language) related to the function, performance, and so on of the element that can be included in the structured design information. The assistance apparatus 10 generates the explanatory text by inputting a prompt that instructs to create an explanatory text of the structured design information into the language model while referring to (considering) the explanatory information. The assistance apparatus 10 presents the generated explanatory text to the user. The user who sees the explanatory text can easily understand the contents of the structured design information.

### Second Example Embodiment

Next, a second example embodiment will be described in detail with reference to drawings.

In the second embodiment, a case is described in which the assistance apparatus 10 presents to a user information that serves as the basis for generating a draft system configuration, in addition to an explanatory text of structured design information (the draft system configuration) acquired by automated design.

As the information processing system according to the second example embodiment can have the same configuration as that according to the first example embodiment, the description corresponding to FIG. 3 will be omitted.

The following description will be made with a focus on the difference between the first example embodiment and the second example embodiment.

The automated design unit 203 according to the second example embodiment generates information related to a design process for structured design information (hereinafter referred to as “design process information”) while generating the structured design information (draft system configuration) from a system requirement.

Specifically, the automated design unit 203 generates information related to a component required to achieve the requirement described in the system requirement as design process information.

For example, if the system requirement definition states that “A system throughput of at least 10 Mbps is required”, the automated design unit 203 selects “A CPU with a maximum frequency of 4.0 GHz or higher” to achieve this requirement. The automated design unit 203 generates reason for selecting the component selected to achieve the requirement described in the system requirement as the design process information. In the above example, the design process information is generated with content such as “Selecting a CPU with a maximum frequency of 4.0 GHz to achieve a throughput of 10 Mbps.”

Alternatively, the automated design unit 203 may generate the design process information regarding the expected performance if a different component had been selected instead of the component actually adopted. In the above example, if the requirement (throughput of 10 Mbps or more) cannot be achieved by selecting a CPU with a maximum frequency of 2.0 GHz, the design process information is generated with the content “The maximum frequency of 2.0 GHz is not selected because the throughput of 10 Mbps cannot be achieved.”

It should be noted that in generating concrete design information for the system requirement, the automated design unit 203 determines that the system requirement can be achieved if there is a combination of components (concrete component) that satisfies the requirement. The automated design unit 203 only needs to generate the design process information at the time of determining whether or not the system requirement can be achieved. The automated design unit 203 only needs to generate the design process information by combining the system requirement (a requirement related to performance) and the component requirement information (for example, information related to performance) selected in accordance with the requirement.

The automated design unit 203 passes the generated design process information along with the structured design information (draft system configuration) to the explanation control unit 204.

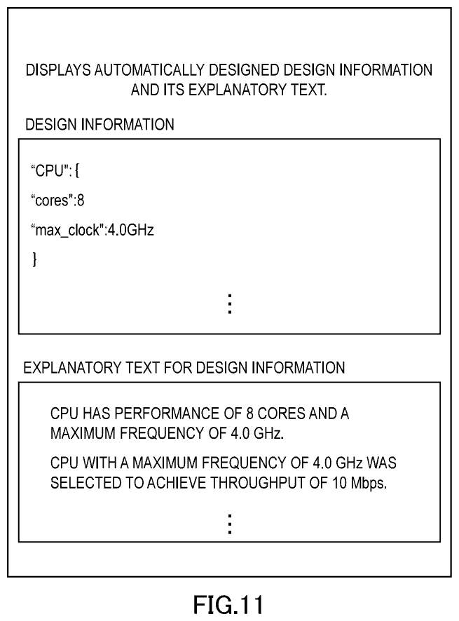

The explanation control unit 204 presents the design process information acquired from the automated design unit 203 to the user, along with an explanatory text for the structured design information (an explanatory text acquired from the language model). For example, the explanation control unit 204 displays a screen including the explanatory text and design process information as shown on FIG. 11 on the terminal 20.

As described above, the assistance apparatus 10 according to the second embodiment generates the design process information related to the generation process of the structured design information. The assistance apparatus 10 presents the design process information to the user along with an explanation of the structured design information. As a result, the user can learn the rationale for adopting the component included in the draft system configuration, and so on.

### Third Example Embodiment

Next, a third example embodiment will be described in detail with reference to drawings.

In the third example embodiment, a case is described in which the assistance apparatus 10 acquires a level of detail (degree of abstraction) that the user requests for an explanatory text of the structured design information, and generates the explanatory text to be presented to the user in accordance with the acquired level of detail.

As the information processing system according to the second example embodiment can have the same configuration as that according to the first example embodiment, the description corresponding to FIG. 3 will be omitted.

The following description will be made with a focus on the difference from the first example embodiment to the third example embodiment.

The automated design unit 203 according to the third example embodiment acquires a degree of detail (level of detail) that the user requests for an explanatory text of design information in acquiring a system requirement, which is the target for generating the design information, using a GUI, and so on.

For example, the automated design unit 203 acquires the level of detail that the user requests for the explanatory text in three stages: “High,” “Medium,” and “Low.” In other words, the automated design unit 203 includes a function as an acquisition means that acquires the level of detail that the user requests for the explanatory text of the structured design information.

If the level of detail acquired from the user is high, it indicates that the user is requesting more information, or more concrete information, about the component, and so on described in the design information. On the other hand, if the level of detail acquired from the user is low, it indicates that the user is requesting the presentation of a schematic or abstract information about the component, and so on, described in the design information.

Here, the automated design unit 203, which adopts the automated design algorithm disclosed in the above Referenced Document 1, generates final design information (draft system configuration) by repeatedly performing operations that progressively concretize the abstract system configuration included in the given system requirement.

In generating the concrete design information described above, the automated design unit 203 uses information that defines the correspondence relationship for converting highly abstract component into more concrete component (hereafter referred to as concretization information). More specifically, the assistance apparatus 10 (the automated design unit 203) stores hierarchical components as concretization information that can be adopted in the system.

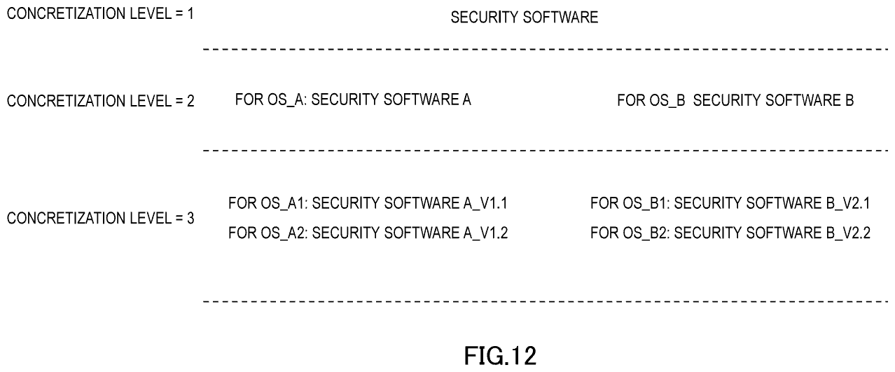

For example, taking “security software” which may be included in the draft system configuration, the automated design unit 203 stores three levels of concretization information as shown in FIG. 12. It should be noted that on FIG. 12, the higher the level of concretization, the more concrete the content of the component becomes.

In the example shown in FIG. 12, the components related to “security software” are described.

For example, at concretization level “1”, the security software itself is set as the component. At concretization level “2”, the name of a specific security software for each OS (operating system) is set as the component. At concretization level “3”, the version of the security software that can be used for each OS version is set as the component.

In this way, the concretization information is information that defines the component of each level (concretization level) for the element that can be included in the design information (draft system configuration). Alternatively, the concretization information is also information that defines the correspondence relationship for converting a first component into a concrete second component.

The automated design unit 203 generates the design information (system design proposal) from the system requirement acquired from the user using the concretization information shown in FIG. 12. Specifically, the automated design unit 203 repeats automatically designing the system until the bottom line of the concretization information (the most concrete component) is acquired.

Once the final design information (structured design information) is acquired, the automated design unit 203 passes the concretization information corresponding to the component included in the structured design information to the explanation control unit 204 as “concrete abstract information”.

For example, in the example in FIG. 12, consider a case where the component “Security software A_V1.1 for OS_A1” is included in the draft system configuration. In this case, the automated design unit 203 generates concrete abstract information such as “Concretization Level 1: Security Software, Concretization Level 2: Security Software A for OS_A, Concretization Level 3: Security Software A_V1.1 for OS_A1.”

The automated design unit 203 passes the level of detail of the explanation text requested by the user, the design information (structured design information) generated from the system requirement, and the concretization information (concrete abstract information) related to the element included in the design information to the explanation control unit 204.

For example, if the design information (draft system configuration) includes the component “security software”, the automated design unit 203 passes the level of detail acquired from the user, the structured design information, and the concrete abstract information given in the example above to the explanation control unit 204.

The explanation control unit 204 generates an explanatory text of the structured design information using the information acquired from the automated design unit 203. Specifically, the explanation control unit 204 generates a prompt that instructs the language model to generate the explanatory text of the structured design information in accordance with the level of detail acquired from the automated design unit 203.

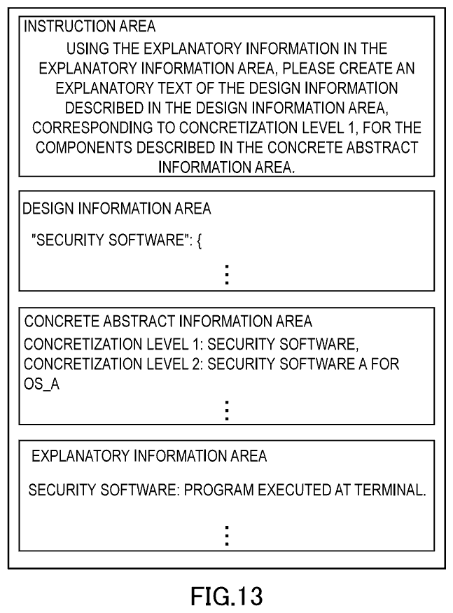

For example, as shown in FIG. 13, the explanation control unit 204 generates a prompt that includes four areas: an instruction area, a design information area, a concrete abstract information area, and an explanatory information area.

In the design information area, the structured design information (draft system configuration) described in the first example embodiment, and so on is described. In addition, in the explanatory information area, the design information stored in the storage unit 205 is described, as described in the first example embodiment, and so on.

In the concrete abstract information area, the concrete abstract information acquired from the automated design unit 203 is described.

The explanation control unit 204 describes an instruction in the instruction area to generate an explanatory text corresponding to the level of detail requested by the user, based on the information described in each area: the design information area, the concrete abstract information area, and the explanatory information area.

For example, the explanation control unit 204 describes in the instruction area “Please use the explanatory information in the explanatory information area to create an explanatory text for the design information described in the design information area, which corresponds to the concretization level Z for the component described in the concrete abstract information area. It should be noted that the “Z” in “concretization level Z” among the instructions described in the instruction area is set to the level of detail desired by the user.

For ease of understanding, the level of detail acquired from the user and the concretization level of concrete abstract information are assumed to correspond one-to-one. Specifically, a level of detail of “low” corresponds to concretization level 1, and a level of detail of “high” corresponds to concretization level 3.

If the level of detail acquired from the user and the concretization level do not correspond one-to-one, the explanation control unit 204 may convert the level of detail to a concretization level in accordance with a predetermined rule, and so on. For example, if the level of detail has three stages and the concretization level has nine stages, the explanation control unit 204 may convert the level of detail input by the user to one of the concretization levels 1, 4, or 7.

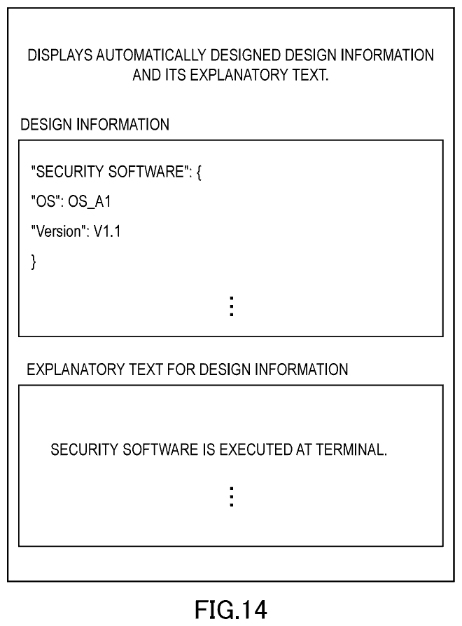

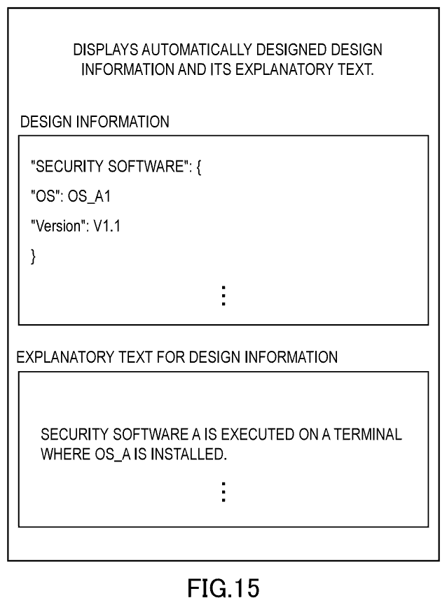

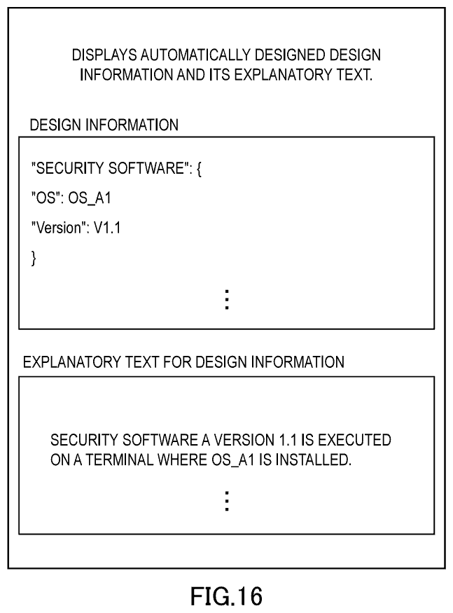

For example, if the user requests an explanation of the design information with a level of detail of “low”, the explanation control unit 204 generates an explanatory text as shown in FIG. 14. Alternatively, if the user requests an explanation of the design information with a level of detail of “medium”, the explanation control unit 204 generates an explanatory text as shown in FIG. 15. Alternatively, if the user requests an explanation of the design information with a level of detail of “high”, the explanation control unit 204 generates an explanatory text as shown in FIG. 16.

In this way, the explanation control unit 204 generates a prompt that instructs the language model to generate explanatory text of the structured design information corresponding to the level of detail requested by the user, using the concretization information (concrete abstract information) corresponding to the component included in the structured design information. The explanation control unit 204 presents the user with the explanatory text acquired by inputting the generated prompt into the language model.

Next, variations according to the third example embodiment will be described.

### <Variation 1>

The explanation control unit 204 may generate a prompt that includes a specific example in accordance with the level of detail requested by the user. That is, the explanation control unit 204 may change the level of abstraction of the specific example to be included in the prompt in accordance with the level of detail requested by the user.

### <Variation 2>

In generating concretization information related to the component included in the structured design information, the automated design unit 203 may generate the component corresponding to the level of detail acquired from the user as concrete abstract information. For example, in the above example, if the user wishes for a level of detail of “high”, the automated design unit 203 may generate concrete abstract information including “OS_A1 security software A_V1.1”.

In this case, the explanation control unit 204 describes content in the instruction area such as “Please use the explanatory information in the explanatory information area to create an explanatory text for the design information described in the design information area for the component described in the concrete abstract information area.” In other words, since the component that has been reflected the level of detail desired by the user is described in the concrete abstract information acquired by the explanation control unit 204, the explanation control unit 204 is not required to generate a prompt in accordance with the level of detail.

As described above, the assistance apparatus 10 according to the third example embodiment acquires the level of detail (degree of abstraction) of an explanation for an explanatory text from the user, and generates the explanatory text with content corresponding to the acquired level of detail. As a result, the user can acquire the explanatory text that meets their needs.

The higher the level of detail in the explanatory text (the lower the degree of abstraction), the more concrete information the user can acquire from the explanatory text. However, it often takes a long time and a lot of effort for the user to understand a detailed explanatory text. On the other hand, the lower the level of detail in the explanatory text (the higher the degree of abstraction), the less information the user can acquire from the explanatory text, but the user can easily understand the presented explanatory text. If the user is an engineer, or the like who is engaged in concrete system design, then the user requires concrete information about the system design proposal. Therefore, such a user is more likely to specify a high level of detail and request an explanatory text for structured design proposal. On the other hand, if the user is a sales representative, or the like who only needs to have a general understanding of the system design, it is often sufficient for them to know the outline information of the system design. Therefore, such a user is more likely to specify a low level of detail and request an explanatory text for structured design proposal. By acquiring the level of detail that the user requires in the explanatory text, the assistance apparatus 10 can provide an explanatory text that aligns with the user's position and needs.

### Fourth Example Embodiment

Next, a fourth example embodiment will be described in detail with reference to drawings.

In the fourth example embodiment, a case is described in which the assistance apparatus 10 provides an interface that allows the user to select (specify) at least one or more components from among the components included in the structured design information for which the user requests an explanation.

As the information processing system according to the fourth example embodiment can have the same configuration as that according to the first example embodiment, the description corresponding to FIG. 3 will be omitted.

The following description will be made with a focus on the difference from the first example embodiment to the fourth example embodiment.

The explanation control unit 204 according to the fourth example embodiment, upon acquiring the structured design information from the automated design unit 203, presents the acquired design information to a user. While presenting the structured design information to the user, the explanation control unit 204 acquires a component among the components included in the design information, for which the user request an explanation.

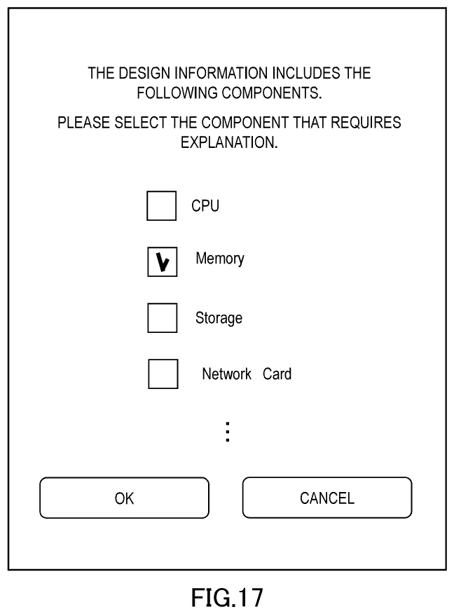

For example, the explanation control unit 204 generates a list of components included in the design information and displays, on the terminal 20, a GUI that allows the user to select a component for which an explanation is desired from among the generated list. For example, the explanation control unit 204 displays a GUI on the terminal 20 as shown in FIG. 17.

Once the user selects the components for which the user request an explanation, the explanation control unit 204 generates a prompt to generate an explanatory text for the selected component. For example, if a user requests an explanation of “Memory”, the explanation control unit 204 generates a prompt such as “Please create an explanatory text for Memory described in the design information area using the explanatory information described in the explanatory information area.”

The explanation control unit 204 presents the explanatory text acquired by inputting the generated prompt into the language model to the user.

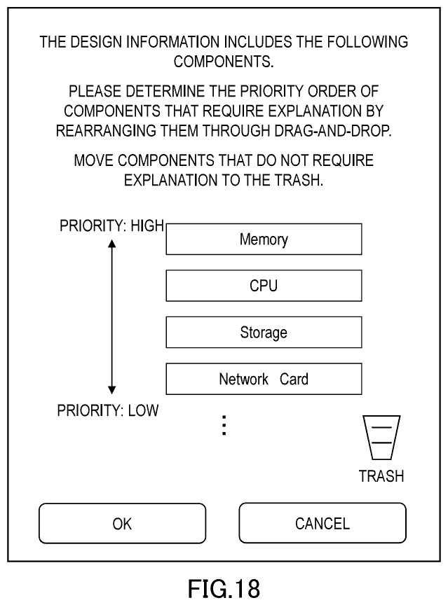

Alternatively, the explanation control unit 204 may display a GUI on the terminal 20 that allows the user to assign priorities to the components included in the list. For example, the explanation control unit 204 may display a GUI such as the one shown in FIG. 18 on the terminal 20.

Once the priority order of the components for which the user requests an explanation is acquired, the explanation control unit 204 generates a prompt to create explanatory texts in the order desired by the user. For example, if the user requests an explanation for

“Memory” followed by “CPU,” the explanation control unit 204 generates a prompt such as, “Please use the explanatory information described in the explanatory information area and create the explanatory texts in the order of Memory and CPU described in the design information area.”

The explanation control unit 204 presents the user with the explanatory text acquired by inputting the generated prompt into the language model.

As described above, the assistance apparatus 10 according to the fourth example embodiment acquires the component for which the user requests an explanation from among the at least one or more components included in the structured design information. The assistance apparatus 10 generates a prompt that instructs the language model to generate an explanatory text for the structured design information related to the acquired component. The assistance apparatus 10 presents the user with the explanatory text acquired by inputting the generated prompt into the language model. As a result, the user can acquire an explanatory text for the component the user genuinely wish to understand.

### Fifth Example Embodiment

Next, a fifth example embodiment will be described in detail with reference to drawings.

In the fifth example embodiment, a case is described in which the assistance apparatus 10 accepts a question, a request, and so on from the user related to the explanatory text presented to the user.

As the information processing system according to the fifth example embodiment can have the same configuration as that according to the first example embodiment, the description corresponding to FIG. 3 will be omitted.

The following description will be made with a focus on the difference from the first example embodiment to the fifth example embodiment.

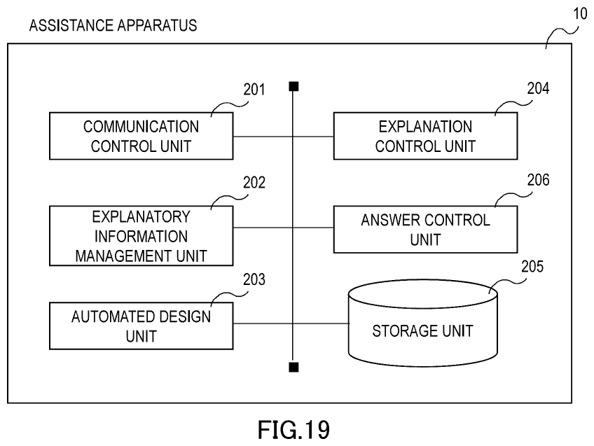

FIG. 19 is a diagram illustrating an example of a processing configuration (processing modules) of the assistance apparatus 10 according to an example embodiment of the present application. Referring to FIG. 19, an answer control unit 206 is added to the configuration of the assistance apparatus 10 according to the first example embodiment.

The answer control unit 206 is means for accepting a user question or request related to the explanatory text presented to the user, and for providing a response to the accepted request.

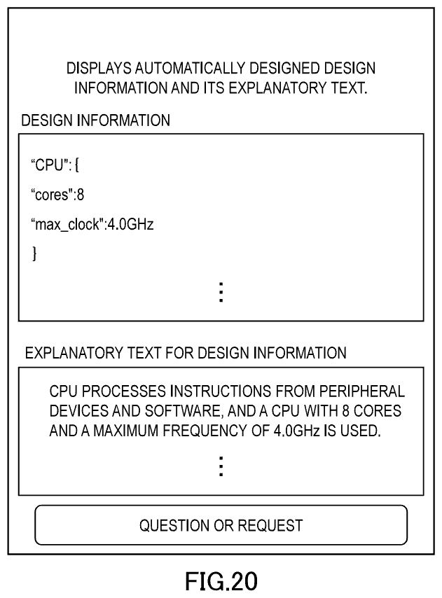

For example, in a case where the explanation control unit 204 presents the explanatory text to the user, the explanation control unit 204 displays a GUI on the terminal 20, as shown in FIG. 20.

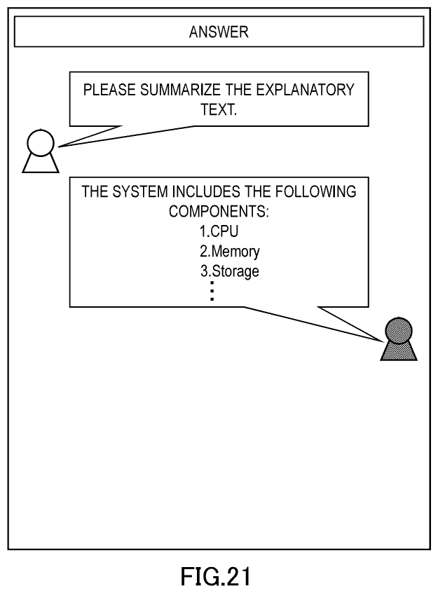

Once the “Question or Request” button is pressed, the answer control unit 206 accepts a question or request from the user related to the presented explanatory text to the user. For example, the answer control unit 206 displays a conversational interface, as shown in FIG. 21.

The answer control unit 206 accepts a user question or request through the interface shown in FIG. 21. The answer control unit 206 generates a prompt to be input into the language model based on the question or request acquired from the user.

For example, in a case where the user requests a summary of the explanatory text, the answer control unit 206 generates a prompt instructing the creation of a summary. Alternatively, in a case where the user desires to extract the explanatory text related to a predetermined component, the answer control unit 206 generates a prompt that specifies the component to be extracted and includes an instruction to extract the component from the explanatory text.

The answer control unit 206 presents the user with an answer acquired by inputting the generated prompt into the language model. The answer control unit 206 may also accept further questions, requests, and so on related to the answer presented to the user.

As described above, the assistance apparatus 10 according to the fifth example embodiment acquires a question or request from the user related to the explanatory text presented to the user, and generates an answer to the acquired question or request using a language model. As a result, the user can acquire more detailed information about the item described in the presented explanatory text.

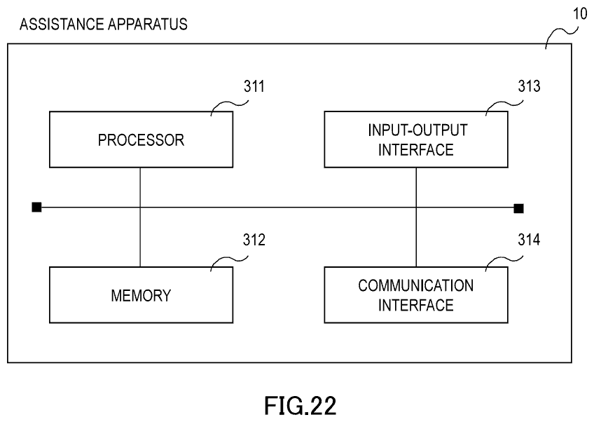

Next, a hardware configuration of an individual apparatus that constitutes the information processing system will be described. FIG. 22 is a diagram illustrating an example of a hardware configuration of the assistance apparatus 10.

The assistance apparatus 10 can be configured by an information processing apparatus (a so-called computer) and has a configuration illustrated as an example in FIG. 22. For example, the assistance apparatus 10 includes a processor 311, a memory 312, an input-output interface 313, a communication interface 314, and so on. The components such as the processor 311 are connected to an internal bus, and so on so that these components can communicate with each other.

The hardware configuration of the assistance apparatus 10 is not limited to the configuration illustrated in FIG. 22. The assistance apparatus 10 may include hardware not illustrated or may be configured without the input-output interface 313 if desired. In addition, the number of components, such as the number of processors 311, included in the assistance apparatus 10 is not limited to the example illustrated in FIG. 22. For example, a plurality of processors 311 may be included in the assistance apparatus 10.

The processor 311 is a programmable device such as a CPU (Central Processing Unit), an MPU (Micro Processing Unit), a DSP (Digital Signal Processor), a TPU (Tensor Processing Unit), a GPU (Graphics Processing Unit (GPU), or the like. Alternatively, the processor 311 may be a device such as an FPGA (Field Programmable Gate Array) or an ASIC (Application Specific Integrated Circuit). The processor 311 executes various kinds of programs including an operating system (OS).

The memory 312 is a RAM (Random Access Memory), a ROM (Read-Only Memory), an HDD (Hard Disk Drive), an SSD (Solid State Drive), or the like. The memory 312 stores an OS program, an application program, and various kinds of data.

The input-output interface 313 is an interface for a display apparatus and an input apparatus not illustrated. For example, the display apparatus is a liquid crystal display and so on. For example, the input apparatus is an apparatus that receives user operations, and examples of the input apparatus include a keyboard and a mouse.

The communication interface 314 is a circuit, a module, and so on for performing communication with other apparatuses. For example, the communication interface 314 includes a NIC (Network Interface Card) and so on.

The functions of the assistance apparatus 10 are realized by various kinds of processing modules. The processing modules are realized, for example, by causing the processor 311 to execute a program stored in the memory 312. In addition, this program can be recorded in a computer-readable storage medium. The storage medium may be a non-transient (non-transitory) storage medium, such as a semiconductor memory, a hard disk, a magnetic recording medium, or an optical recording medium. That is, the present invention can be embodied as a computer program product. In addition, the above program may be updated by downloading a program via a network or by using a storage medium in which a program is stored. In addition, the above processing modules may be realized by semiconductor chips.

As is the case with the assistance apparatus 10, the terminal 20 can each be configured by an information processing apparatus, and the basic hardware configuration of terminal 20 is the same as that of the assistance apparatus 10. Thus, description of the basic hardware configuration of the terminal 20 will be omitted.

The assistance apparatus 10 which is an information processing apparatus includes a computer and can realize its functions by causing the computer to execute a program. In addition, the assistance apparatus 10 executes a control method of the assistance apparatus 10 by using this program.

[Variations] The configurations, operations, and so on of the information processing system according to the above example embodiments are examples and do not limit the present system configuration, and so on.

The assistance apparatus 10 may perform concretization of the system requirement using the language model instead of or in addition to an algorithm for solving a multi-objective optimization problem or an automated design algorithm. For example, the assistance apparatus 10 may generate a prompt that includes the system requirement, and an instruction related to generating a concrete configuration draft of the system requirement, and acquire the concrete configuration draft by inputting the prompt into the language model.

In the above example embodiments, the assistance apparatus 10 has described the structuring of design information, using the JSON format as an example. However, it is obvious that the assistance apparatus 10 may generate design information in other formats. For example, the assistance apparatus 10 may generate design information that includes RDF (Resource Description Framework) format or XML (Extensible Markup Language) format. The assistance apparatus 10 may generate design information in any format that can be processed by a machine.

In the above example embodiments, an example has been described in which the language model is implemented in the assistance apparatus 10. However, the language model may be implemented in a server or the like that is different from the assistance apparatus 10. In this case, the assistance apparatus 10 generates a prompt to be input to the language model and transmits the generated prompt to an external server (a server on which the language model is implemented). The assistance apparatus 10 may acquire an output of the language model (for example, explanatory text of structured design information) from the external server.

The assistance apparatus 10 may retain the general technical information and knowledge information for each technical field (for each type of system). For example, the assistance apparatus 10 may store the technical information for each system, such as an information distribution system, an online conference system, and a face recognition system. It should be noted that, in this case, before the assistance apparatus 10 provides a service to the user, the assistance apparatus 10 may acquire the type of or the like of the system that the user intends to design, and generate the design information or the like in accordance with the acquired system.

In the above example embodiments, an example has been described in which the assistance apparatus 10 is realized as a server in a server-client system. However, the assistance apparatus 10 may also be realized by the terminal 20 of a user in which a predetermined application is installed.

In the flowcharts and sequence diagrams used in the above description, a plurality of steps (processes) are sequentially described. However, the order of the execution of the steps performed in the individual example embodiment is not limited to the described order. In the individual example embodiment, the order of the illustrated steps may be changed to the extent that a problem is not caused on the content of the individual example embodiment. For example, individual processes may be executed in parallel.

The above example embodiments have been described in detail to facilitate the understanding of the present application disclosed and not to mean that all the configurations described above are needed. In addition, if a plurality of example embodiments have been described, each of the example embodiments may be used individually or a plurality of example embodiments may be used in combination. For example, part of a configuration according to one example embodiment may be replaced by a configuration according to another example embodiment. For example, a configuration according to one example embodiment may be added to a configuration according to another example embodiment. In addition, addition, deletion, or replacement is possible between part of a configuration according to one example embodiment and another configuration.

The industrial applicability of the present invention has been made apparent by the above description. That is, the present invention is suitably applicable, for example, to information processing systems and the like that assist system design by users.

### [Supplementary Note 1]

An information processing apparatus, including:
a storage means that stores explanatory information for each element that can be included in structured design information;
a generation means that generates a prompt to be input into a language model, the prompt instructing the language model to generate an explanatory text for the structured design information using the stored explanatory information; and
a presentation means that presents the acquired explanatory text of the structured design information by inputting the generated prompt into the language model to a user.

### [Supplementary Note 2]

The information processing apparatus according to supplementary note 1, wherein the generation means generates the prompt that instructs the language model to generate the explanatory text that explains the structured design information from a function perspective or a performance perspective.

### [Supplementary Note 3]

The information processing apparatus according to supplementary note 2, further including an automated design means that acquires a system requirement from the user and generates the structured design information from the acquired system requirement.

### [Supplementary Note 4]

The information processing apparatus according to supplementary note 3, wherein the automated design means further generates design process information related to a generation process of the structured design information, and
wherein the presentation means presents the design process information to the user along with the explanation of the structured design information.

### [Supplementary Note 5]

The information processing apparatus according to supplementary note 3 or 4, further including an acquisition means that acquires a level of detail that the user requests for the explanatory text of the structured design information, and
wherein the generation means generates the prompt that instructs the language model to generate the explanatory text of the structured design information in accordance with the acquired level of detail.

### [Supplementary Note 6]

The information processing apparatus according to supplementary note 5, wherein the automated design means generates the structured design information from the system requirement by using concretization information that defines a correspondence relationship for converting a first component into a concrete second component, and
wherein the generation means generates the prompt that instructs the language model to generate the explanatory text of the structured design information corresponding to the acquired level of detail by using the concretization information corresponding to a component included in the structured design information.

### [Supplementary Note 7]

The information processing apparatus according to any one of supplementary notes 1 to 4, wherein the generation means acquires the component for which the user requests an explanation from among the at least one or more components included in the structured design information, and generates the prompt that instructs the language model to generate the explanatory text for the structured design information related to the acquired component.

### [Supplementary Note 8]

The information processing apparatus according to any one of supplementary notes 1 to 4, further including an answer means that acquires a question or request from the user related to the presented explanatory text presented, and generates an answer to the acquired question or request using the language model.

### [Supplementary Note 9]

A control method of an information processing apparatus, the control method including:
a storage step that stores explanatory information for each element that can be included in structured design information;
a generation step that generates a prompt to be input into a language model, the prompt instructing the language model to generate an explanatory text for the structured design information using the stored explanatory information; and
a presentation step that presents the acquired explanatory text of the structured design information by inputting the generated prompt into the language model to a user.

### [Supplementary Note 10]

The control method of the information processing apparatus according to supplementary note 9, wherein the generation step generates the prompt that instructs the language model to generate the explanatory text that explains the structured design information from a function perspective or a performance perspective.

### [Supplementary Note 11]

The control method of the information processing apparatus according to supplementary note 10, further including an automated design step that acquires a system requirement from the user and generates the structured design information from the acquired system requirement.

### [Supplementary Note 12]

The control method of the information processing apparatus according to supplementary note 11, wherein the automated design step further generates design process information related to a generation process of the structured design information, and
wherein the presentation step presents the design process information to the user along with the explanation of the structured design information.

### [Supplementary Note 13]

The control method of the information processing apparatus according to supplementary note 11 or 12, further including an acquisition step that acquires a level of detail that the user requests for the explanatory text of the structured design information, and
wherein the generation step generates the prompt that instructs the language model to generate the explanatory text of the structured design information in accordance with the acquired level of detail.

### [Supplementary Note 14]

The control method of the information processing apparatus according to supplementary note 13, wherein the automated design step generates the structured design information from the system requirement by using concretization information that defines a correspondence relationship for converting a first component into a concrete second component, and wherein the generation step generates the prompt that instructs the language model to generate the explanatory text of the structured design information corresponding to the acquired level of detail by using the concretization information corresponding to a component included in the structured design information.

### [Supplementary Note 15]

The control method of the information processing apparatus according to any one of supplementary notes 9 to 12, wherein the generation step acquires the component for which the user requests an explanation from among the at least one or more components included in the structured design information, and generates the prompt that instructs the language model to generate the explanatory text for the structured design information related to the acquired component.

### [Supplementary Note 16]

The control method of the information processing apparatus according to any one of supplementary notes 9 to 12, further including an answer step that acquires a question or request from the user related to the presented explanatory text presented, and generates an answer to the acquired question or request using the language model.

### [Supplementary Note 17]

A program causing a computer mounted on an information processing apparatus to perform processing for:
a storage processing that stores explanatory information for each element that can be included in structured design information;
a generation processing that generates a prompt to be input into a language model, the prompt instructing the language model to generate an explanatory text for the structured design information using the stored explanatory information; and
a presentation processing that presents the acquired explanatory text of the structured design information by inputting the generated prompt into the language model to a user.

### [Supplementary Note 18]

The program according to supplementary note 17, wherein the generation processing generates the prompt that instructs the language model to generate the explanatory text that explains the structured design information from a function perspective or a performance perspective.

### [Supplementary Note 19]

The program according to supplementary note 18, further performing an automated design processing that acquires a system requirement from the user and generates the structured design information from the acquired system requirement.

### [Supplementary Note 20]

The program according to supplementary note 19, wherein the automated design processing further generates design process information related to a generation process of the structured design information, and
wherein the presentation processing presents the design process information to the user along with the explanation of the structured design information.

### [Supplementary Note 21]

The program according to supplementary note 19 or 20, further performing an acquisition processing that acquires a level of detail that the user requests for the explanatory text of the structured design information, and
wherein the generation processing generates the prompt that instructs the language model to generate the explanatory text of the structured design information in accordance with the acquired level of detail.

### [Supplementary Note 22]

The program according to supplementary note 21, wherein the automated design processing generates the structured design information from the system requirement by using concretization information that defines a correspondence relationship for converting a first component into a concrete second component, and
wherein the generation processing generates the prompt that instructs the language model to generate the explanatory text of the structured design information corresponding to the acquired level of detail by using the concretization information corresponding to a component included in the structured design information.

### [Supplementary Note 23]

The program according to any one of supplementary notes 17 to 20, wherein the generation processing acquires the component for which the user requests an explanation from among the at least one or more components included in the structured design information, and generates the prompt that instructs the language model to generate the explanatory text for the structured design information related to the acquired component.

### [Supplementary Note 24]

The program according to any one of supplementary notes 17 to 20, further performing an answer processing that acquires a question or request from the user related to the presented explanatory text presented, and generates an answer to the acquired question or request using the language model.

Furthermore, all or part of the configurations described in supplementary note 2 to supplementary note 8, which depend on supplementary note 1, may also depend on supplementary note 9 and supplementary note 17 in the same manner as supplementary note 2 to supplementary note 8. Furthermore, not limited to supplementary note 1, supplementary note 9, and supplementary note 17, within the scope that does not deviate from the embodiments described above, all or part of the configurations described as supplementary notes may similarly depend on various hardware, software, various recording means for recording software, or systems.

The entire disclosure of the above patent literature is incorporated herein by reference thereto. While the example embodiments of the present invention have thus been described, the present invention is not limited to these example embodiments. It is to be understood to those skilled in the art that these example embodiments are only examples and that various variations are possible without departing from the scope and spirit of the present invention. That is, the present invention of course includes various variations and modifications that could be made by those skilled in the art in accordance with the overall disclosure including the claims and the technical concept.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents. Further, it is noted that the inventor's intent is to retain all equivalents of the claimed disclosure even if the claims are amended during prosecution.

What is claimed is:

1. An information processing apparatus, comprising:
at least one memory storing a set of instructions; and
at least one processor configured to execute the set of instructions to:
store explanatory information for each element that can be included in structured design information;
generate a prompt to be input into a language model, the prompt instructing the language model to generate an explanatory text for the structured design information using the stored explanatory information; and
present the acquired explanatory text of the structured design information by inputting the generated prompt into the language model to a user.

2. The information processing apparatus according to claim 1, wherein
the at least one processor is further configured to execute the set of instructions to generate the prompt that instructs the language model to generate the explanatory text that explains the structured design information from a function perspective or a performance perspective.

3. The information processing apparatus according to claim 2, wherein
the at least one processor is further configured to execute the set of instructions to acquire a system requirement from the user and generates the structured design information from the acquired system requirement.

4. The information processing apparatus according to claim 3, wherein
the at least one processor is further configured to execute the set of instructions to;
generate design process information related to a generation process of the structured design information; and
present the design process information to the user along with the explanation of the structured design information.

5. The information processing apparatus according to claim 3, wherein
the at least one processor is further configured to execute the set of instructions to:
acquire a level of detail that the user requests for the explanatory text of the structured design information; and
generate the prompt that instructs the language model to generate the explanatory text of the structured design information in accordance with the acquired level of detail.

6. The information processing apparatus according to claim 5, wherein
the at least one processor is further configured to execute the set of instructions to:
generate the structured design information from the system requirement by using concretization information that defines correspondence relationship for converting a first component into a concrete second component; and
generate the prompt that instructs the language model to generate the explanatory text of the structured design information corresponding to the acquired level of detail by using the concretization information corresponding to a component included in the structured design information.

7. The information processing apparatus according to claim 1, wherein
the at least one processor is further configured to execute the set of instructions to:
acquire the component for which the user requests an explanation from among the at least one or more components included in the structured design information; and
generate the prompt that instructs the language model to generate the explanatory text for the structured design information related to the acquired component.

8. The information processing apparatus according to claim 1, wherein
the at least one processor is further configured to execute the set of instructions to acquires a question or request from the user related to the presented explanatory text presented, and generates an answer to the acquired question or request using the language model.

9. The information processing apparatus according to claim 2, wherein
the at least one processor is further configured to execute the set of instructions to acquires a question or request from the user related to the presented explanatory text presented, and generates an answer to the acquired question or request using the language model.

10. The information processing apparatus according to claim 3, wherein
the at least one processor is further configured to execute the set of instructions to acquires a question or request from the user related to the presented explanatory text presented, and generates an answer to the acquired question or request using the language model.

11. The information processing apparatus according to claim 4, wherein
the at least one processor is further configured to execute the set of instructions to acquires a question or request from the user related to the presented explanatory text presented, and generates an answer to the acquired question or request using the language model.

12. A control method of an information processing apparatus, the control method comprising:
storing explanatory information for each element that can be included in structured design information;
generating a prompt to be input into a language model, the prompt instructing the language model to generate an explanatory text for the structured design information using the stored explanatory information; and
presenting the acquired explanatory text of the structured design information by inputting the generated prompt into the language model to a user.

13. A non-transitory computer-readable storage medium storing a program causing a computer mounted on an information processing apparatus to perform processing for:
storing explanatory information for each element that can be included in structured design information;
generating a prompt to be input into a language model, the prompt instructing the language model to generate an explanatory text for the structured design information using the stored explanatory information; and
presenting the acquired explanatory text of the structured design information by inputting the generated prompt into the language model to a user.
